(19) United States
(12) Patent Application Publication
(10) Pub. No.: US 2006/0064467 A1
(43) Pub. Date: Mar. 23, 2006

(54) System and method for partial web page caching and cache versioning

(76) Inventor: Michael L. Libby, Leesburg, VA (US)

Correspondence Address: LAW OFFICE OF DUANE S. KOBAYASHI, 1325 MURRAY DOWNS WAY, RESTON, VA, 20194, US

(21) Appl. No.: 10/943,020

(22) Filed: Sep. 17, 2004

(51) Int. Cl. G06F 15/16

(52) U.S. Cl. 709/217

(57) ABSTRACT

A system and method for enabling versioning and partial web page caching is disclosed. One of the features of the present invention is the use of version information in the caching process at a server site to identify partial web page modifications. A second feature is the capability at the client site to identify, receive, and display individual portions of a web page. This avoids the necessity of having the client receive whole page content when only a portion of that content has changed. Advantages of the present invention include a reduction in the server processing load as well as a reduction in the use of bandwidth utilization, an assurance that web page data is current in both server and client cache, and a dramatic increase in the speed of web page presentation.

### BACKGROUND

1. Field of the Invention

The present invention relates generally to computer systems, the Internet, and specifically to a system and method for versioning and partial web page caching.

2. Introduction

The level of network traffic on the World Wide Web is growing exponentially in line with user demand for up-to-date network content and the desire of web creators to supply that demand in the most efficient way possible. Given current bandwidth availability, various methods continue to be explored to speed up the delivery and receipt of web page content.

Caching technology (i.e., storage and use of data in a computer system) is one of the technologies currently employed to improve the transmission/receipt of web page content. Such strategy is used at both server and client sites. One example of a limitation in current caching methodology is the caching of an entire web page at the client site. In this process, presentation of website content might not be current.

What is needed therefore is a system and method that improves current caching systems and methods to thereby address current constraints in bandwidth and potential lack of current content at client.

### SUMMARY

The present invention meets the above-mentioned challenge by providing a system and method of synchronizing server-client cache. One feature of the present invention is the creation of a method of versioning that enables the explicit specification of a particular partial modification of a web page by the server. A second feature of the present invention is a caching system that enables the client to identify, receive, and display only the updated page content.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a web page;

FIG. 2 illustrates a system of the present invention;

FIG. 3 illustrates a flowchart of a process for responding to a web page request from a client;

FIG. 4 illustrates a flowchart of a process for rendering a web page at a client using a client cache;

FIG. 5 illustrates a flowchart of a frame resizing process; and

FIG. 6 illustrates a flowchart of a process for responding to a request for content that is not resident in a client cache.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Limitations in the bandwidth of any user's Internet connection can greatly reduce the quality of the user's Internet experience. Chief among the problems that are experienced is the delay in rendering web pages that are transmitted. As the content included within a typical web page becomes even more focused on multi-media, this problem is expected to increase as users are forced to download larger and larger files for rendering on a particular web page.

It is a feature of the present invention that a user's web experience can be improved through the reduction in the amount of content that needs to be transmitted. In general, this reduction is achieved through the leveraging of cache technology, especially at the client site in synchronization with changes in cache at the server site. At the client site, the client cache minimizes the portions of a web page that need to be rebuilt at the server, thereby resulting in the reduction of the server's load. As will be described in greater detail below, the client cache and the server cache can be kept dynamically in-sync with content residing at the server.

In accordance with the present invention, a client cache is used to cache portions (or fragments) of a web page. In general, these portions (or fragments) of the web page can represent any part of a web page that can be separately identified from the entire web page. For example, in one scenario, the portion of the web page can represent a fragment of a web page that is to be displayed through a frame of a skeleton page. In one embodiment, the skeleton page represents a web page implementing partial web page caching technology. In various examples, the fragment can be embodied as its own HTML document, a web user control, or any other web page component that can be separately defined.

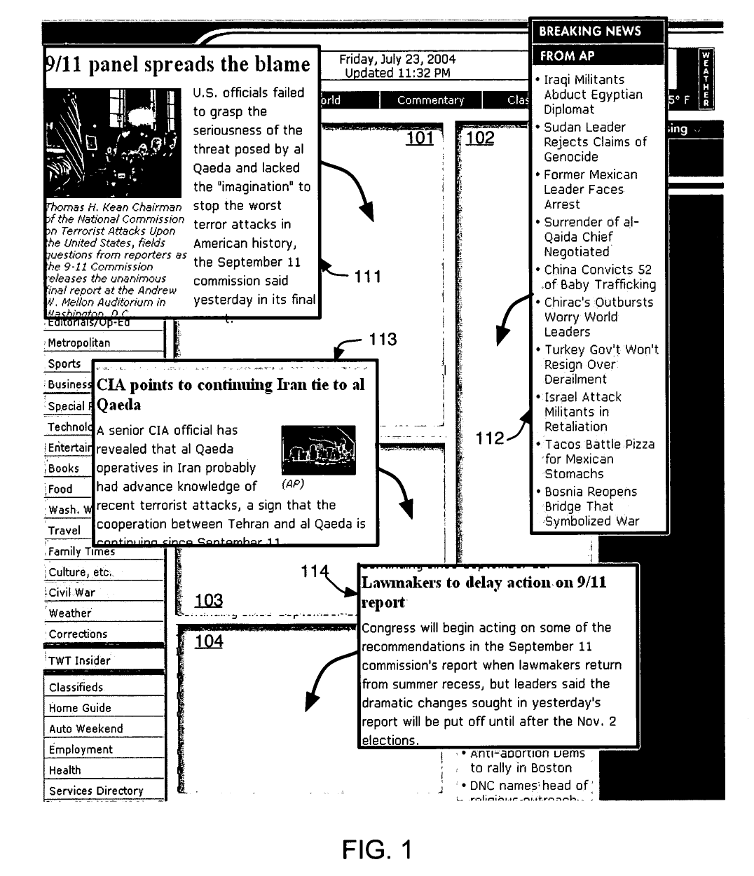

FIG. 1 illustrates an embodiment of a skeleton page having a plurality of fragments that are displayed through a plurality of frames. As illustrated in FIG. 1, the skeleton page includes frames 101-104. Fragments 111-114 would then be displayed through frames 101-104, respectively. As would be appreciated, a plurality of fragments could be displayed through one particular frame under the control of, for example, a timer or other user menu selection mechanism.

In another example, the portion of the web page can represent an image file, identified by an image source tag, that can be displayed within a skeleton page or a fragment. In the more detailed description below, the principles of the present invention are described with reference to an example of fragments that are displayable through a plurality of frames within a defined skeleton page.

In accordance with the present invention, the plurality of fragments within a skeleton page can be stored individually in a client's cache. These fragments are dynamic because they are only downloaded from the server when their physical display properties or textual content changes. This partial caching process is in contrast to conventional methods that cache entire web pages at the client for a predefined expiration period or cache no part of the web page.

In one embodiment, because web page fragments are stored in the client's cache, subsequent visits to the web page initially retrieve only a skeleton page from the server. This skeleton page enables the synchronization of the client's cached fragments with the server data. In general, the skeleton page can be designed to store a uniform resource locator (URL) to each fragment that is to be displayed on the skeleton page. In one embodiment, this fragment URL can be formatted to include a reference to a proxy page that is used to construct web page components that cannot independently render themselves separate of a web page. The proxy page can therefore be used to render controls that are dependant upon being constructed from within a web page.

When the skeleton page attempts to load these URLs into frames of the skeleton page, it first looks for the fragments in the client's cache. If the fragments identified by the URLs are found in the client cache, then the cached fragments are retrieved and immediately rendered in the skeleton page. If the fragments identified by the URLs are not found in the client cache, then the fragments are requested from the server, rendered in the skeleton page, and then stored in the client's cache for subsequent page requests.

It is a feature of the present invention that the fragment URLs that are downloaded in the skeleton page include version information. In one embodiment, the version information includes a reference number. In another embodiment, the version information includes a timestamp of the date and time that the fragment file was last modified. In this framework, the version information would change when the fragment's content changes at the server. Because the version information is embedded within the fragment's URL, a change in the version information effectively changes the fragment's entire URL. Thus, if the fragment's entire URL is changed, the fragment will not be found in the client's cache. This causes the client to request the newly modified fragment from the server. The previous fragment identified by the fragment URL with the old version information would simply be abandoned.

With this general caching framework, only a small skeleton page would be downloaded from the server on subsequent visits to that web site. Any fragments that are unchanged would be immediately retrieved from the client's cache and displayed. Only changed fragments would need to be downloaded from the server. This savings in bandwidth would enable a modem operating at 28.8 kbps to download a 5 KB skeleton page in less than 2 seconds. Fragments, no matter how large, would be retrieved from the client's cache within milliseconds. If any of the fragment versions have changed then only that changed fragment is requested from the server.

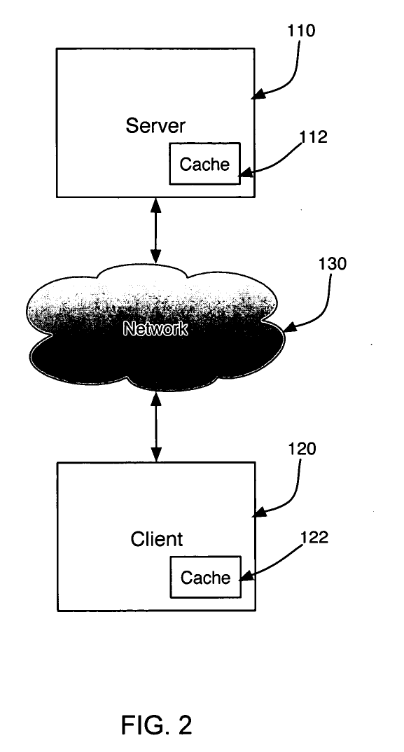

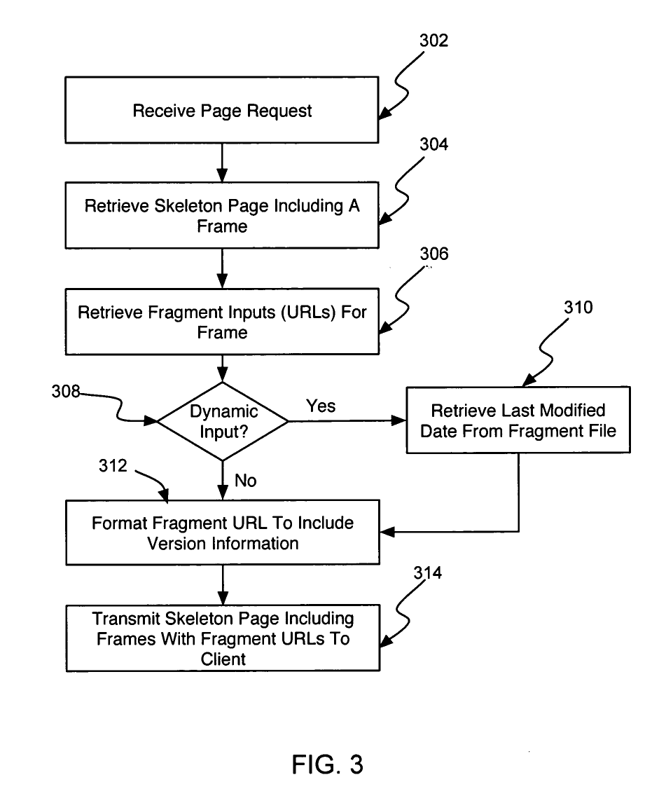

Having described the general framework of a client caching mechanism, a more detailed description of the caching process is now provided. In this description, reference is made to the generic system components that are illustrated in FIG. 2. As illustrated in FIG. 2, the system generally includes a client 120 in communication with a server 110 via network 130. As would be appreciated, network 130 generally encapsulates any network infrastructure that would support a general communication channel through which client-server communication would pass. In one embodiment, network 130 would include any system components that would support the handling of Internet traffic. As further illustrated in FIG. 2, client 120 includes client cache 122, while server 110 includes server cache 112. The cooperation of both server cache 112 and client cache 122 in the overall process is now described with reference to the flowcharts of FIGS. 3-5.

FIG. 3 illustrates a flowchart of a process for serving a skeleton page that includes frames through which fragments may be displayed. At design time, the designer would specify which fragments (e.g., HTML pages, web user controls, or the like) are to be placed on a skeleton page. In various embodiments, this specification can be performed using a design-time property, XML, or a program interface. In one example, a new or existing control could be included with the following line of ASPX code:

<summitsw:AvidCache id=“MyCache”

ACFragmentSrc=“UserControl.ascx”
runat=“server”/>

The following example further shows how to use an XML file to enable display of a different fragment within a single frame every six seconds:

<summitsw:AvidCache id=“MyCache”

ACUrl=“MyCache.xml”
CycleRate=“6000”
EnableViewState=“false”
runat=“server”/>

With the XML file format as:

<ACFragments>

<ACFragment ACUrl=“Page.htm”/>
<ACFragment ACUrl=“UserControl1.ascx ”/>
<ACFragment ACUrl =“UserControl2.ascx ”/>

</ACFragment>

After the various fragments have been specified for a particular skeleton page, the skeleton page can then be used in responding to a web page request. As illustrated in FIG. 3, this process begins at step 302 where server 110 receives a page request from client 120. At step 304, server 110 would then retrieve the skeleton page that is associated with the page request. As noted above, this skeleton page can be designed to include one or more frames, such as frames 101-104 in FIG. 1. Next, at step 306, server 110 would retrieve input (e.g., xml document, a code behind method call, or a property) for each frame that can include a list of fragment uniform resource locators (URLs) that is to be included. As will be described in greater detail below, the content corresponding to this list of fragment URLs can be cached in client cache 122. The retrieved fragment URLs would then be formatted prior to being sent to the client as part of the skeleton page. In one embodiment, the fragment URL is formatted to include a reference to the proxy page along with versioning information.

It is a feature of the present invention that part of this format includes the fragment's version information. In one embodiment, this version information is a version number. In another embodiment, this version information is the date/time that the fragment was last modified.

For each URL input, at step 308, it is determined whether the input is dynamic. Examples of dynamic URL inputs can be represented by the following:
<ACItem ACURL=“page1.htm” Version=“Dynamic”/>
AvidCache .ACItem.Add(UserControl.acsx, VersionType.Dynamic);
   While an example of a static URL input can be represented by the following:
<ACItem ACURL=“UserControl.ascx “Version=“yyyymmddhhmmss”/>;
AvidCache.ACItem.Add(UserControl.ascx, VersionType. Static, “20040916124301”).

If it is determined at step 308, that the URL input is dynamic, then at step 310, the fragment's last modified date is retrieved from the fragment file and used for the version information. This returned version information is then used as an input to the process at step 312 where the fragment URL is formatted to include the version information. If it is determined at step 308, that the URL input is static (i.e. the version is defined by the implementing web application), then the version information is already available in the URL input and the process can proceed directly to formatting step 312.

At step 312, each fragment URL is reformatted by inserting the proxy page and changing the fragment URL by appending the version information. In one embodiment, the fragment URLs can be placed in the following format where the version information is represented by the time stamp having a format of “yyyymmddhhmmss.”
AvidCache.aspx?ACFragment=Webpage1.htm?Version=yyyymmddhhmmss
AvidCache.aspx?ACFragment=UsrCtrl1.htm?Version=yyyymmddhhmmss
AvidCache.aspx?ACFragment=UsrCtrl2.htm?Version=yyyymmddhhmmss

Once formatted, the fragment URLs are put into an array on the skeleton page. This skeleton page can then be sent to the client at step 314.

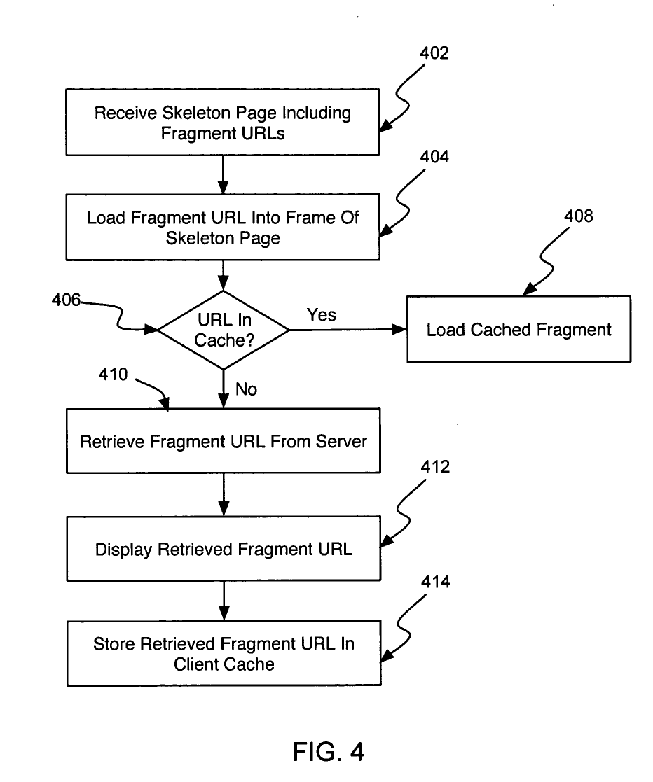

FIG. 4 illustrates a flowchart of a process for rendering a web page based on the skeleton page that is received from the server in cooperation with a client cache. As illustrated, the process begins at step 402 where the client receives the skeleton page that includes the fragment URLs. At step 404, each of the fragment URLs that are to be displayed through a frame of the skeleton page is loaded. In general, there can be an unlimited number of frames in a skeleton page. The number of frames is limited only by how much content can logically fit on the skeleton page. Moreover, frames can also be nested within other frames. For example, an aspx skeleton page can contain a frame that displays a user control that contains another frame.

At step 406, it is then determined for each of the fragment URLs that are sought to be loaded, whether the fragment URL exists in client cache 122. If the fragment URL exists in client cache 122, then, at step 408, the cached fragment identified by the fragment URL is loaded into the frame, a process that can be completed in milliseconds.

At this point, it should be noted again that the process of step 406 is based on the caching of individual fragments and not entire web pages. Each individual fragment is identified by a URL that has been augmented with version information that enables the client to determine whether a fragment identified by the skeleton page has been modified since the last time the client retrieved that skeleton page from the server. For example, if the skeleton page includes the fragment URL “UsrCtrl1.htm?Version=20040802090134” having version information reflecting a last modified date of 9:01:34 AM on Aug. 2, 2004, then the client would determine whether that entire fragment URL including the version information was located in the client cache. If that particular fragment URL string is located in the client cache, then the fragment would be immediately retrieved from the client cache. If, on the other hand, the same fragment used in the previous visit to that skeleton page had different version information (e.g., “UsrCtrl1.htm?Version=20040730141212 having version information reflecting a last modified date of 2:12:12 PM on Jul. 30, 2004), then the search for the fragment URL string “UsrCtrl1.htm?Version=20040802090134” would turn up empty notwithstanding the existence of the previous fragment URL string “UsrCtrl1.htm?Version=20040730141212” in the client cache. In effect, this process dictates that outdated fragment URLs in the client cache are not used and simply ignored. As far as the client is concerned, the non-existence of the current fragment URL in the client cache indicates that a request to the server for the current fragment URL is needed to fully render the web page at the client.

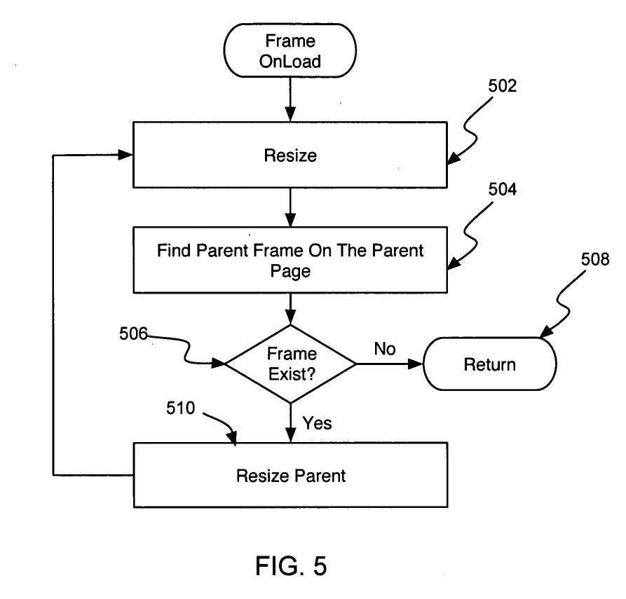

Referring again to FIG. 4, this process is illustrated, at step 406, by the determination that the fragment URL is not in the client cache. Upon this determination, the process would then continue to step 410 where the fragment URL is retrieved from the server. Details of the process in the server in responding to this fragment URL request is described below with reference to the flowchart of FIG. 5. Once the fragment URL is retrieved from the server it is displayed in its frame at step 412, then stored in the client cache at step 414.

In one embodiment, the frame in which a fragment URL is displayed is automatically resized to fit the size of the content. This resizing can occur whenever the content within a frame changes, such as, for example, when a plurality of fragments of different size are sequentially displayed within a particular frame. In another scenario, the resizing can occur when content within a nested frame changes. Consider for example, a scenario where a particular frame of a skeleton page has a first frame nested within a second frame, which in turn is nested within a third frame. Upon display, assume that only the first frame has changed. The client would then retrieve the highest two frame levels (i.e., second and third frame) from the client cache and request the modified first frame from the server. This modified first frame may have a different content size as compared to the previous first frame that was retrieved. Upon display of the newly-retrieved first frame, the second frame in which the first frame is nested could then be resized, followed in turn by the resizing of the third frame in which the second frame is nested. In general, the resizing of frames can be implemented to ensure that content can be displayed without cropping (loss of) content or the unnecessary or undesirable display of scroll bars. In general, frames often have to be resized because in most cases the length of the frame isn't known until the frame's content is rendered on the client computer.

FIG. 5 illustrates an embodiment of a resizing process. As illustrated, the resizing process begins when the frame within a parent page has its OnLoad event fired (triggered). If the frame includes a plurality of nested frames, then the process would first apply to the inner most frame and would then proceed outward to the outer most frame. On loading of the inner most frame, the process would begin at step 502 where the parent page's Resize method is invoked. Next, at step 504, a search is performed to find a parent frame on the parent page. In one embodiment, the process looks for a frame on the parent page that has the same URL as the current page.

At step 506, it is determined whether a parent frame exists. If no parent frame exists, then the frame is not nested within another frame and the resizing process ends. If, on the other hand, it is determined at step 506 that a parent frame exists, then a resize parent method is invoked at step 510, whereupon a recursive call is made back to step 502. In one embodiment, the frame is resized to the length of the scrollbar. An implementation of the Resize and ParentResize methods in JavaScript is illustrated below.

function PPCReSize(frm)
{

var theFrame = eval(frm);
var autoheight = eval(‘AHT’ + frm);
if (theFrame.document.body != null && theFrame.document.body.scrollHeight > 0
&& theFrame.location.host.length > 0 && autoheight == true)
{

document.getElementById(frm).style.height=theFrame.document.body.scrollHeight;

PPCReSizeParent(frm);

}
return false;

}
function PPCReSizeParent(frm)
{

var frms = parent.document.all.tags(‘IFrame’);
for (i=0; i<frms.length; i++)
{

var srchfor = frms[i].src;
if (srchfor.length > 0 && frms[i].name == ‘AvidCache’ &&

location.href.indexOf(srchfor) > −1)

{

window.parent.PPCReSize(frms[i].id);
break;

}

}

}

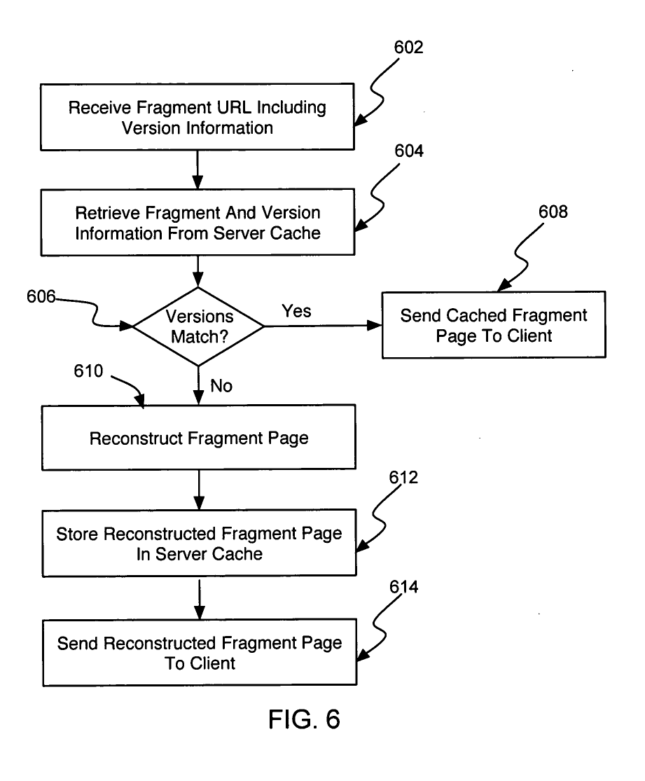

FIG. 6 illustrates a flowchart of a process by which the server responds to a client request for a fragment URL that includes version information. In one embodiment, the fragment URL request generated by a client includes the proxy page with parameters including the fragment filename and relative path from the proxy page, any fragment parameters, and the version information. The receipt of the fragment URL request at the server begins the process at step 602.

At step 604, the server then retrieves fragment and version information from the server cache. In an embodiment, the server uses the fragment URL without the version information as a key into the server cache. In this embodiment, the cache key would be used to retrieve cached data that includes the version information for that particular fragment. Here, it should be noted that the use of a cache key without the version information would enable the server to find the fragment in cache regardless of its version. This is in contrast to the client cache search process, which seeks to find only a particular version of a fragment in the client cache.

Once the version information is retrieved from the server cache, the retrieved version information can then be compared to the version information included in the client's fragment URL request. If, at step 606, it is determined that the version information matches, then the fragment cached in the server cache can be retrieved and sent to the client at step 608.

If, on the other hand, the version information does not match, then the process continues at step 610 where the fragment page is reconstructed by the server. At step 612, the reconstructed fragment page then replaces the previously stored fragment in the server cache. Finally, at step 614, the reconstructed fragment page is sent to the client

In combination, the processes of FIGS. 3-6 provide a fragment caching process that enables a client to minimize the amount of content requested from the server. This greatly reduces the bandwidth requirements in rendering a web page, thereby increasing the speed at which a web page can be displayed. Further, any reduction in content requested of the server reduces the load required of the server to construct complete web pages and avoids the necessity of having to reconstruct total content for subsequent users. Also, versioning keeps client and server cache synchronized with content residing at the server.

As noted, one of the significant features of the present invention is the ability to accommodate the separate caching of portions of a web page at the client site. This is in contrast to the caching of entire web pages. As would be appreciated, the principles of the present invention can be applied at various levels of granularity. In particular, it should be noted that the principles of the present invention can be applied at any web page component level that can be individually identified and modified. For example, as noted above, web page images can be individually cached at the client site to thereby ensure that new requests for that figure are only made when a change to that image has been made at the server. In this example, a change to the image would also be reflected by a change in version information in the image's file name. This filename would then be propagated back to the client by changing the HTML page to include the image's changed filename. In-turn, the HTML version would also change. The client, not finding either the HTML page or image in it's cache is then forced to make another request from the server. This is in contrast to conventional methods where if the entire page or fragment containing that image is cached as a whole, then any change in the entire page or fragment (even those unrelated to the image) would cause the client to request the entire page or fragment including a second request for the previously downloaded image file.

In addition to savings in bandwidth, the principles of the present invention also enable a reduction in ambiguity as to the use of the most recently updated information. Conventionally, time-limited cache items represent the only mechanism for controlling the use of outdated cached items. This conventional mechanism, however, provides no insight into whether a particular item to be displayed is outdated.

In accordance with the present invention, the use of version information in the skeleton page and the client cache, enables the client to identify immediately whether items stored in the client cache are up to date. If the cached item is outdated, it can be ignored since the cache search for an entry that includes specific version information would turn up empty. As soon as the client detects that the server's new version of the data is not available at the client, a request is then made to the server. Not only does this ensure that only necessary requests are made, but it also ensures that outdated information is never used nor displayed.

Although the above description may contain specific details, they should not be construed as limiting the claims in any way. Other configurations of the described embodiments of the invention are part of the scope of this invention. Accordingly, only the appended claims and their legal equivalents should define the invention, rather than any specific examples given.

What is claimed is:

1. A method for reducing bandwidth requirements in delivering content to a client computer, comprising:
a. receiving a content request from a client computer;
b. transmitting computer readable program code to said client computer, said computer readable program code enabling said client computer to render a skeleton page containing at least one frame, said frame used for displaying a fragment identified by a versioned uniform resource locator string that includes version information;
c. receiving a request for said fragment from said client computer if said fragment identified by said versioned uniform resource locator string is not stored in a client cache;
d. retrieving said fragment identified by said versioned uniform resource locator string; and
e. transmitting said retrieved fragment to said client computer.

2. The method of claim 1, wherein said skeleton page includes a plurality of fragments that are identified by distinct versioned uniform resource locator strings.

3. The method of claim 1, wherein said versioning information includes a version number.

4. The method of claim 1, wherein said versioning information includes information reflective of a time or date.

5. The method of claim 1, wherein said fragment is a HTML page.

6. The method of claim 1, wherein said fragment is a web user control.

7. The method of claim 1, further comprising reformatting a static versioned uniform resource locator string.

8. The method of claim 1, further comprising reformatting a dynamic versioned uniform resource locator string, said reformatting including:
a. retrieving a last modified date from a fragment stored in a database; and
b. including said retrieved last modified date in a uniform resource locator string.

9. A method for caching content in a client computer, comprising:
a. receiving information that includes a resource reference, said resource reference including version information;
b. determining whether content referenced by said resource reference is included in a client cache;
c. if said content referenced by said resource reference is included in said client cache, then retrieving said content from said client cache; and
d. rendering said content on said client computer.

10. The method of claim 9, wherein if said content referenced by said received uniform resource locator string is not included in said client cache, then requesting said content from a server.

11. The method of claim 9, wherein said versioning information includes a version number.

12. The method of claim 9, wherein said versioning information includes information reflective of a time or date.

13. The method of claim 9, wherein said received information is a skeleton page.

14. The method of claim 13, wherein said uniform resource locator string references a web page fragment for rendering in a frame of said skeleton page.

15. The method of claim 9, wherein said content is a HTML page.

16. The method of claim 9, wherein said content is a web user control.

17. The method of claim 9, wherein said received information is a HTML page and said uniform resource locator string is part of an image source tag.

18. The method of claim 9, wherein said rendering comprises resizing said content.

19. The method of claim 18, wherein said resizing comprises resizing to a length of a scrollbar.

20. A method for displaying content in a client computer, comprising:
a. loading a first frame of content;
b. resizing said first frame of content;
c. determining whether said first frame of content is nested within a second frame of content; and
d. if said first frame of content is nested within said second frame of content, then resizing said second frame of content after said first frame of content has been resized.

21. The method of claim 20, wherein said resizing comprises resizing to a length of a scrollbar.

22. A method for caching an image in a client computer, comprising:
a. receiving a skeleton page that includes an image source reference, said image source reference including version information;
b. determining whether an image file referenced by said image source reference is included in a client cache;
c. if said image file source referenced by said image source reference is included in said client cache, then retrieving said image file from said client cache; and
d. displaying said image file on said client computer.

23. A method for caching web content in a server, comprising:
a. receiving a content request from a client computer, said content request including a uniform resource locator string;
b. retrieving said content identified by said received uniform resource locator string from a server cache;
c. determining whether version information for said cached content matches version information included with said received uniform resource locator string;
d. reconstructing content identified by said content request if said determination does not indicate a match;
e. caching said reconstructed content in said server cache; and
f. transmitting said reconstructed content to said client computer.

24. The method of claim 23, further comprising transmitting said retrieved content to said client computer if said determination indicates a match.

25. The method of claim 23, wherein said version information includes a version number.

26. The method of claim 23, wherein said version information includes information reflective of a time or date.

27. The method of claim 23, wherein said retrieving comprises accessing said server cache using a cache key based on said received uniform resource locator string without version information.

28. The method of claim 23, wherein said caching comprises replacing a previously cached content with said reconstructed content if said previously cached content is outdated.
